(19) United States
(12) Patent Application Publication
(10) Pub. No.: US 2025/0304384 A1
(43) Pub. Date: Oct. 2, 2025

(54) COLD WALL LOCKHOPPER

(71) Applicant: GTI ENERGY, Des Plaines, IL (US)

(72) Inventors: Jeffrey A. MAYS, Woodland Hills, CA (US); Scott Trybula, Evergreen Park, IL (US); Kiran Chaudhari, Manvel, TX (US); Shinjiro Miyata, Malibu, CA (US); Abdelallah Ahmed, Glen Ellyn, IL (US); John C. Vega, III, Camarillo, CA (US)

(73) Assignee: GTI ENERGY, Des Plaines, IL (US)

(21) Appl. No.: 19/097,319

(22) Filed: Apr. 1, 2025

Related U.S. Application Data
(60) Provisional application No. 63/572,436, filed on Apr. 1, 2024.

(51) Int. Cl. B65G 53/36; B65G 53/16; B65G 53/60

(52) U.S. Cl. CPC B65G 53/36; B65G 53/16; B65G 53/60; B65G 2201/04; B65G 2207/22

(57) ABSTRACT

A lockhopper for the safe handling of hot solids preferably includes an outer vessel and an inner vessel positioned within the outer vessel to form an annulus volume between an exterior of the inner vessel and an interior of the outer vessel. Insulation and/or a gas gap are preferably positioned within the annulus volume.

### CROSS REFERENCE TO RELATED APPLICATION

This application claims the benefit of U.S. Provisional Patent Application Ser. No. 63/572,436, filed on 1 Apr. 2024. The co-pending provisional application is hereby incorporated by reference herein in its entirety and is made a part hereof, including but not limited to those portions which specifically appear hereinafter.

### STATEMENT REGARDING FEDERALLY SPONSORED RESEARCH

This invention was made with government support under Award Number DE-EE0008637 awarded by U.S. Department of Energy. The government has certain rights in the invention.

### BACKGROUND OF THE INVENTION

### Field of the Invention

This invention relates to a lockhopper for transferring hot solids.

### Description of Related Art

The handling and transfer of hot solids can be hazardous and inefficient.

Lockhoppers provide a system for operation of a feeding device that generally has low-pressure capability to operate at much higher pressures. Lockhoppers also permit continuous conveying from a single material feeding device. Lockhoppers are typically located between a supply hopper, at atmospheric pressure to allow continuous loading of material, and the material feeding device, which can be at any pressure.

Lockhoppers are typically filled from an overhead hopper. The lockhopper is then pressurized to the same pressure as a connected blow tank. With the transfer vessel at the same pressure as the blow tank, the blow tank can be topped up to maintain a continuous flow of material. Once the material has been loaded into the blow tank, the lockhopper is vented to return it to atmospheric pressure. The lockhopper can then be loaded with another batch of material from the supply hopper. Throughout these operations, the lockhopper generally operates at very high temperatures when transferring hot solids. Such temperatures typically extend to exterior surfaces of the lockhopper, thereby affecting ambient conditions and operator safety.

There is a need for a capability to transfer hot solids while maintaining a cold wall of the lockhopper.

### SUMMARY OF THE INVENTION

The subject invention is directed to a coldwall lockhopper used for transferring solids. The lockhopper allows for hot (>800° F.) solids transfer while maintaining a cold (140° F.) wall for safe handling. This system mitigates heat loss of the solids which can then be used for the downstream process. The subject invention accomplishes this by insulation rather than active cooling, which saves on costs and complexity.

The cold wall lockhopper according to an embodiment of this invention is a jacketed vessel where the inner vessel is used to transfer hot solids (>800° F.) while the outer vessel acts as a buffer to outside handlers. There is insulation between the two vessels to mitigate heat loss which also results in the outer vessel remaining at temperatures less than 140° F., the OSHA safety limit for handling. The inner vessel is preferably bonded to the outer vessel at the inlet and is snug fit at the outlet to allow for differences in thermal expansion. The outer vessel preferably includes two side ports that are used to allow pressurizing/depressurizing gas to enter and exit. The inner vessel preferably includes filtered ports to allow for the pressurizing/depressurizing gas to enter while ensuring the solids doesn't escape.

Other objects and advantages will be apparent to those skilled in the art from the following detailed description taken in conjunction with the appended claims and drawings.

### BRIEF DESCRIPTION OF THE DRAWINGS

FIG. 1 is a cross-sectional side perspective view of a lockhopper according to one embodiment of the invention;

FIG. 2 is a cross-sectional side view of the lockhopper shown in FIG. 1; and

FIG. 3 is a cross-sectional side view of the lockhopper shown in FIG. 1, approximately 90 degrees from the side view shown in FIG. 2.

### DETAILED DESCRIPTION OF THE INVENTION

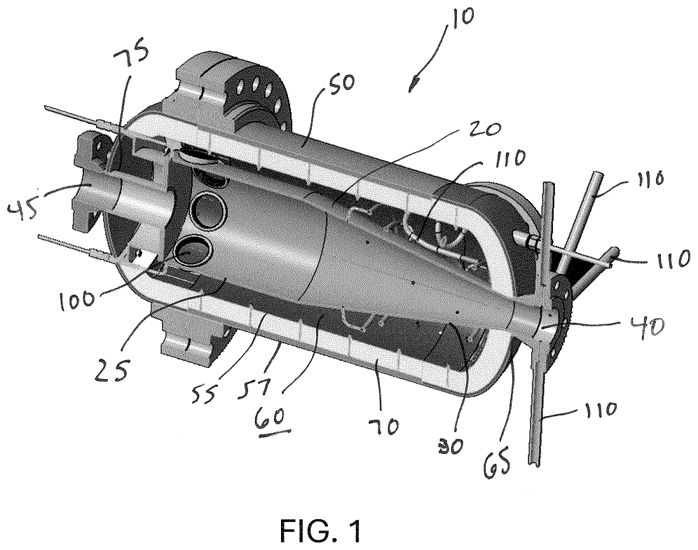

The subject invention is shown in FIGS. 1-3 and comprises a lockhopper 10 that preferably maintains outer wall temperature less than 140° F. for safe handling while internally transporting solids with temperatures exceeding 800° F. Given the desired application, the subject lockhopper 10 is preferably capable of more than 2 million cycles at pressure ramp and decay rates of greater than 2 psi per second.

A lockhopper 10 for the safe handling of hot solids, as shown in FIGS. 1-3, preferably includes an inner vessel 20 and an outer vessel 50. The inner vessel 20 is preferably mechanically bonded by bolts or weld to an inlet 75 of the outer vessel 50. Hot solids are preferably transported within the inner vessel 20 while an outer wall 57 of the outer vessel 50 remains at a safe temperature.

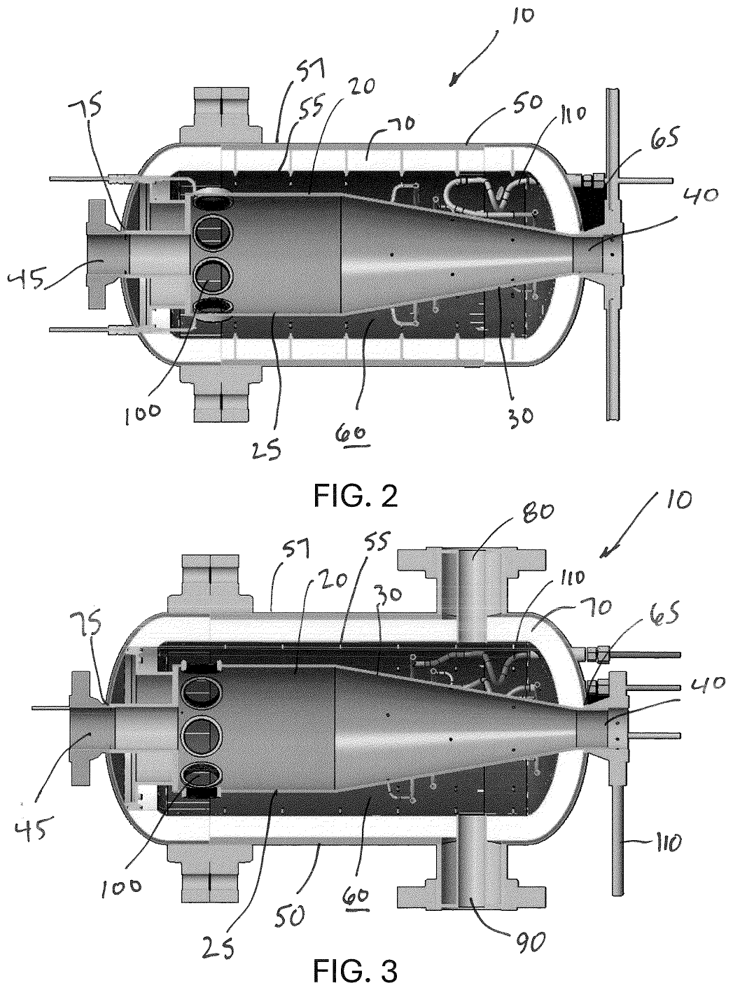

According to an embodiment shown in FIGS. 1 and 2, the inner vessel 20 includes a straight walled portion 25 and a conical walled portion 30. The conical walled portion 30 preferably diverges from an inner wall 55 of the outer vessel 50. The outer vessel 50 is preferably flanged on the inlet 75 (top) and outlet 65 (bottom) for flow of the solids. The outer vessel 50 preferably further includes two ports 80, 90 on a side for pressurizing and depressurizing gas, respectively. The inner vessel 20 preferably includes an inner inlet 45 bonded to an outer inlet 75 of the outer vessel 50.

An annulus volume 60 is preferably formed between the inner vessel 20 positioned within the outer vessel 50. Specifically, the annulus volume 60 is preferably formed between an exterior of the inner vessel 20 and an interior of the outer vessel 50.

A means for solids filtration is preferably included between the inner vessel 20 and the outer vessel 50. As shown in FIGS. 1-3, such means may include an array of filtered ports 100 opened to the annulus volume 60 to allow for the flow of pressurizing and depressurizing gas while restricting solids flow to within the inner vessel 20.

A means for providing aeration gas to the inner vessel 20 is shown in FIGS. 1-3. An array of aeration tubes 110 are preferably positioned along a conical portion 30 of the inner vessel 20 and are fed from the outer vessel 50 using fittings or welds to seal. The aeration tubes 100 are preferably coiled or bent within the annulus volume 60 to relieve stresses caused by thermal expansion. The aeration tubes 110 are preferably fed through the wall of the inner vessel 20 and sealed using welds.

A means for providing thermal isolation between the inner vessel 20 and the outer vessel 50 is preferably provided. According to a preferred embodiment, insulation 70 is positioned within the annulus volume 60. The insulation 70 is preferably held tightly to an inner wall of the outer vessel 50. The insulation 70 may be maintained in position within the annulus volume 60 using a plurality of removable fasteners. In addition, or alternatively, the annulus volume 60 may include a gas gap between the inner vessel 20 and the outer vessel 50.

In addition, a means for allowing thermal expansion of the inner vessel 20 is preferably provided. According to a preferred embodiment, such means for allowing thermal expansion of the inner vessel 20 may include an outlet 40 of the inner vessel 20 that snugly fits within an outlet 65 of the outer vessel 50. However, the connection between the respective outlets 40, 65 of the inner vessel 20 and outer vessels 50 are preferably not bonded as to allow it to grow due to thermal expansion.

The inner vessel 20 includes an array of filtered ports 100 on its side that is opened to the annulus volume 60 to allow for flow of pressurizing and depressurizing gas while restricting solids flow to within the inner vessel 20. These filtered ports 100 are preferably sized as to minimize pressure differential to within 1 psi from the inner and outer vessels while allowing for rapid pressurizing/depressurizing of greater than 2 psi per second.

While in the foregoing detailed description the subject development has been described in relation to certain preferred embodiments thereof, and many details have been set forth for purposes of illustration, it will be apparent to those skilled in the art that the subject development is susceptible to additional embodiments and that certain of the details described herein can be varied considerably without departing from the basic principles of the invention.

We claim:

1. A lockhopper for the safe handling of hot solids, the lockhopper comprising:
an outer vessel;
an inner vessel positioned within the outer vessel to form an annulus volume between an exterior of the inner vessel and an interior of the outer vessel; and
insulation positioned within the annulus volume.

2. The lockhopper of claim 1 further comprising:
a means for solids filtration between the inner and outer vessel.

3. The lockhopper of claim 1 further comprising:
a means for providing aeration gas to the inner vessel.

4. The lockhopper of claim 1 further comprising:
a means for providing thermal isolation between the inner and outer vessels.

5. The lockhopper of claim 4 further comprising a means for allowing thermal expansion of the inner vessel.

6. The lockhopper of claim 1 wherein the inner vessel includes an inner outlet positioned within an outer outlet of the outer vessel, the inner outlet and the outer outlet not bonded with respect to each other.

7. The lockhopper of claim 1 wherein the outer vessel includes a pressurizing port and a depressurizing port.

8. The lockhopper of claim 1 wherein the inner vessel includes an array of filtered ports opened to the annulus volume to allow for the flow of pressurizing and depressurizing gas while restricting solids flow to within the inner vessel.

9. The lockhopper of claim 1 wherein the inner vessel includes a straight walled portion and a conical walled portion, the conical walled portion diverging from an inner wall of the outer vessel.

10. The lockhopper of claim 9 wherein the conical portion includes an array of aeration tubes.

11. The lockhopper of claim 10 wherein the array of aeration tubes are at least one of coiled and bent within the annulus and each are fed through a wall of the inner vessel.

12. The lockhopper of claim 1 wherein a gas gap and insulation fill the annulus volume.

13. The lockhopper of claim 1 wherein the inner vessel includes an inner inlet bonded to an outer inlet of the outer vessel.

14. The lockhopper of claim 13 wherein the inner vessel is bonded to the outer inlet of the outer vessel with bolts or welds.

15. The lockhopper of claim 1 wherein the insulation is maintained in position within the annulus using a plurality of removable fasteners.

16. The lockhopper of claim 1 wherein the outer vessel is flanged at an inlet and an outlet.
